(19) United States
(12) Patent Application Publication
(10) Pub. No.: US 2012/0227310 A1
(43) Pub. Date: Sep. 13, 2012

(54) FISHING LURE

(76) Inventor: Tim A. Jenness, Muskego, WI (US)

(21) Appl. No.: 13/270,673

(22) Filed: Oct. 11, 2011

Related U.S. Application Data
(63) Continuation-in-part of application No. 13/156,060, filed on Jun. 8, 2011.
(60) Provisional application No. 61/404,910, filed on Oct. 12, 2010.

(51) Int. Cl. A01K 85/02; A01K 99/00

(52) U.S. Cl. 43/42.36; 43/42.53

(57) ABSTRACT

A fishing lure capable of sufficiently catching fish, while not getting caught in weeds or similar environments. The lure generally comprises a hook and a main body, with the hook having a barbed portion abutting the underside or belly of the main body when in a normal position and being located externally of the main body when engaging a fish.

### RELATED APPLICATIONS

The present application is a continuation-in-part of U.S. patent application Ser. No. 13/156,060, filed 8 Jun. 2011, which claims the benefit of U.S. Provisional Patent Application Ser. No. 61/404,910, filed on 12 Oct. 2010.

### BACKGROUND OF THE INVENTION

The present invention relates to fishing lures, and, more particularly, fishing lures that are capable of being used in weeds, reeds, or similar environments without the lure being caught or snagged. Such “weedless” lures are beneficial in not only minimizing time and effort in unsnagging lures from the weeds or reeds, but also minimize lost lures that cannot be freed from the reeds.

The prior art has provided some “weedless” lures, but they have their disadvantages. For example, some of these lures have a main design focus of not getting the lure snagged on weeds when trolling with the lure. Examples, of such lures include Boone, U.S. Pat. No. 5,121,567 and Parrish, U.S. Pat. No. 6,722,552. Such types of lures generally have the main body of the lure independently arranged from the fishing hook, which limits the efficiency of the lure to catch fish, or presents potential snagging issues after the lure has been intercepted by a fish. Similarly, such designs may not necessarily be of a shape or size that will properly attract the fish.

Other lures have a more integrated design between the hook and the main body, but still leave room for improvement. For example, Davidson, U.S. Pat. No. 5,379,544, provides a weedless fishing lure, wherein the barb of the hook is located behind a hollowed out dorsal fin. The design still has the potential for the lure to become entangled in weeds. In a similar fashion, the fishing lure described in Lindner et al., U.S. Pat. No. 3,724,116, describes how to integrate the main body of the lure and the hook. However, the arrangement is determinative on the capability of the user to combine the hook and the main body, which can lead to an inefficient design having the hook exposed when being used in weeds. Also, the design does not necessarily ensure that the hook will be sufficiently available to snag a fish once the fish bites or swallows the lure.

### SUMMARY OF THE INVENTION

The present invention provides a “weedless” lure. The lure generally comprises an elongated flexible main body and a hook partially imbedded in the main body, with the barb of the hook extending outwardly of the bottom, i.e. the belly, of the main body. The main body comprises provides a junction wherein the barb of the hook is located. The arrangement allows the hook to flex or move away from the main body when swallowed by a fish. Particularly, the barb will flex outwardly to allow the fish to be snagged.

The design and arrangement of the hook and the elongated body allows the lure to be used in weeds or similar environments without the hook getting caught on the weeds. Similarly, the design of the lure provides a swimming action when the lure is used, thereby providing an attractive lure to a fish.

The elongated body may also be designed with a notched section in the junction that further assists a fisherman in catching fish.

The present invention also contemplates improved methods of catching fish by using the fishing lures of the present invention.

The present invention also contemplates methods of making the fishing lures to incorporate odor enhancements for fishing lure.

### BRIEF DESCRIPTION OF THE DRAWINGS

FIG. 1 is a perspective view of a fishing lure according to the present invention.

FIG. 2 is a perspective view of a second embodiment of a fishing lure according to the present invention.

FIG. 3 is a perspective view of a further embodiment of a fishing lure according to the present invention.

FIG. 4 is a cross-sectional view of a fishing lure according to the present invention.

FIG. 5 is a perspective view of the fishing lure of the present invention being used to catch a fish.

FIG. 6 is an alternative arrangement of a fishing lure according to the present invention.

FIG. 7 is a further embodiment of a fishing lure according to the present invention.

FIG. 8 provides a further arrangement of a fishing lure according to the present invention, wherein the hook portion is perpendicular to the main body of the fishing lure.

FIGS. 9-11 demonstrate a method of making a fishing lure according to the present invention.

FIG. 12 provides an alternate style of fishing lure utilizing the present invention.

FIG. 13 provides another alternate style of fishing lure utilizing the present invention.

FIGS. 14A and 14B provide yet another alternate style of fishing lure utilizing the present invention.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention.

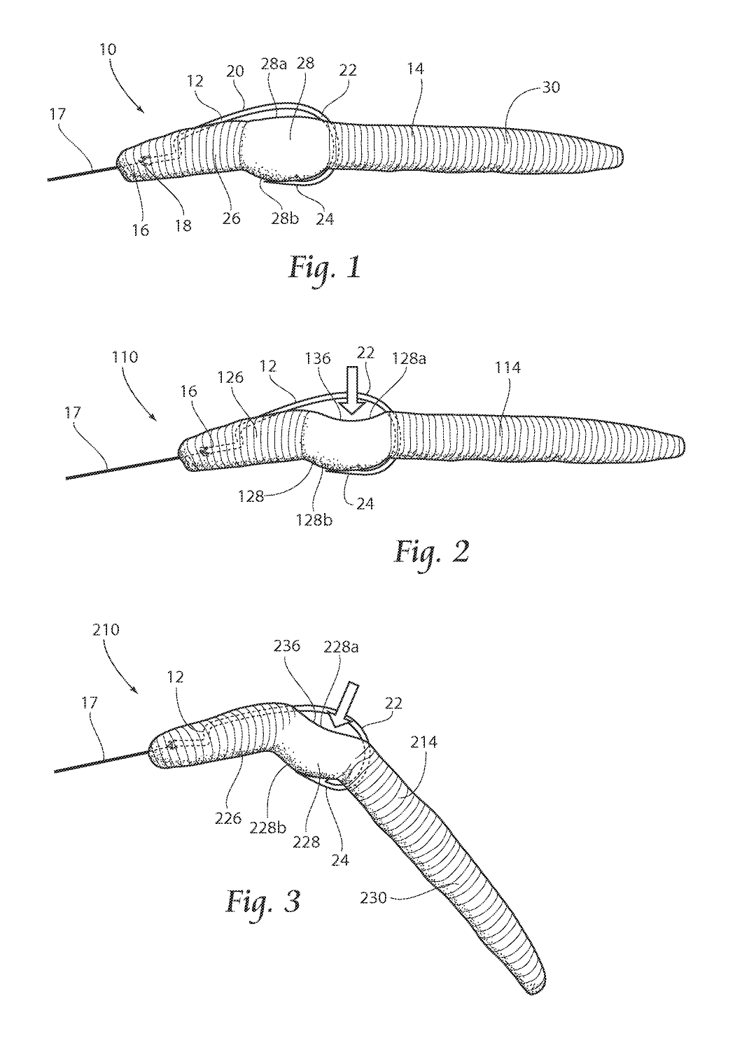

FIG. 1 is a perspective of a fishing lure 10 designed according to the present invention. The fishing lure generally comprises a hook 12 and a main body 14. The hook 12 has a first end 16 comprising an eyelet 18 (shown in phantom) or a similar arrangement that will allow the fishing lure 10 to be connected to a fishing line 17. For example, the first end 16 could comprise a clasp or other means that will allow the hook 12 to be connected to a fishing line or wire. Preferably the first end 16 is embedded inwardly of the main body 14 of the fishing lure 10. The hook 12 has a main shaft 20 and a second curved end 22 comprising a barb 24. The barb 24 can be of any shape or fashion that is typically used for fishing. As demonstrated in FIG. 1, the barb 24 abuts the underside, i.e. the belly, of the main body 14 of the fishing lure 10.

Still referring to FIG. 1, the main body 14 of the fishing lure further comprises a front section 26, a junction or center section 28 and a rear section 30. The front section 26 generally surrounds the main shaft 20 of the hook 12. The curved end 22 and the barb 24 are located generally within the proximity of opposing sides 28a and 28b of the junction 28 when in a normal position. That is, the curved end 22 will extend out of the front section 26 and be exposed on the top side 28a of the junction 28, with the barb 24 of the curved section ending on the bottom side or belly 28b of the junction 28, with the barb 24 preferably positioned as to abut the belly 28b. The use and positioning of the junction 28 assists in the ability of the hook 12 to move with respect to the body 14, while still allowing for the hook 12 to be externally positioned of the body 14 without getting ensnared on weeds or the like.

The rear section 30 is typically an elongated section, having a length that is preferably longer than the front section 26 and the junction 28. However, the rear section 30 can be of any design that will not impede the use of the lure 10 within weeds or similar environments.

FIG. 2 depicts a second embodiment 110 of a fishing lure according to the present invention. The fishing lure 110 is designed and arranged similar to the fishing lure 10, with the exception that it has a junction 128 with a notched area 136. The notched area 136 will be discussed further, below. The hook 12 will interact with a main body 114 similarly as described in FIG. 1. That is, the first end 16 of the hook 12 will be located within a front section 126 of the main body 114, and the curved end 22 and the barb 24 of the hook will be located proximate to the junction 128, with the curved end 22 being proximate to a top side 128a of the junction 128 and the barb 24 being proximate to a bottom side or belly 128b of the junction 128.

FIG. 3 depicts a further embodiment 210 of a fishing lure designed according to the present invention. The fishing lure 210 is designed and arranged similar to the fishing lures 10, 110, with the exception that the three sections of the main body 214 of the fishing lure 210, the front section 226, the junction 228, and the rear section 230, are angled with respect to one another in a non-linear fashion. The junction 228 also has a notched section 236. That is, the rear section 230 is angled with respect to the front section 226, with the junction 228 essentially forming the vertex of the angle. The formed angle may be any angle that prevents tangling of the hook in the weeds. Preferable, the angle will be an acute angle, with a more preferable angle being between about 30° to 60° and a most preferable angle between about 40°-50°. The hook 12 will reside within the front section 226 and the junction 228, similarly as the hook 12 resides within the fishing lure 10, 110 in FIGS. 1 and 2. That is, the curved end 22 of the hook will be proximate to a top side 228a of the junction 228 and the barb 24 of the hook 12 will be proximate a bottom side or belly 228b of the junction 228.

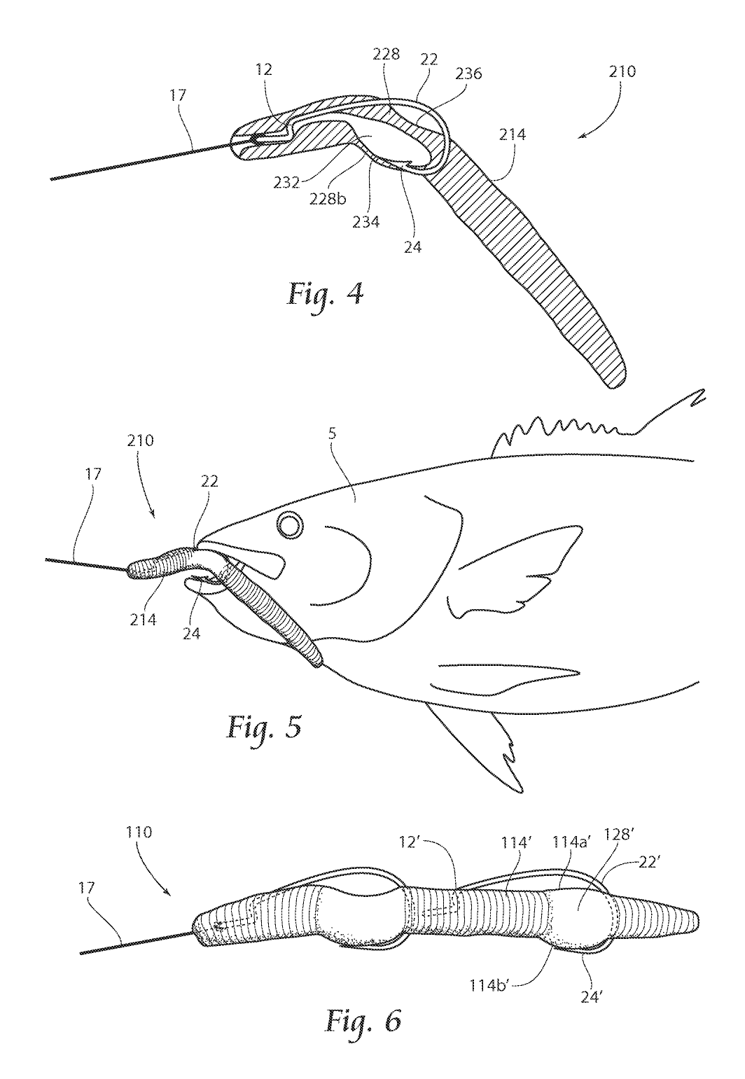

FIG. 4 provides a cross-sectional view of the lure 210, depicting an alternate arrangement of the hook 12 and the main body 214. The hook 12 is generally located centrally within the body 214. The body 114 may also have a cavity 232, which allows the hook 12 potential inward and outward movements with respect to the body 214 when in use. The cavity 232 is preferably located within the junction 228. Such an arrangement will reduce wear on the lure 210 when the hook 12 moves with respect to the body 214 when in use. It is understood that the main body 14 of FIG. 1 (and the main body 114 of FIG. 2) may have a similar cavity 32 (shown in phantom in FIG. 1). Provided that an arrangement will allow the hook 12 to move inwardly and outwardly from the body 214 and the belly 228b and sufficiently keep the barb 24 free of entanglement of weeds, the arrangement will fall within the scope of the present invention.

The purpose of the present invention is to not only provide a fishing lure that will not get entangled in weeds or reeds, but will also be an efficient lure for catching fish. The lures 10, 110 and 210 are designed not only so that the hook 12 does not get entangled within the weeds, but also to solidly ensnare or catch a fish when the fish swallows a lure. To assist in this manner, the lures 110 and 210 (FIGS. 2 and 3, respectively) are shown having a respective notched area 136, 236 located in the junctions 128, 228 of the main body 114, 214. The notched area 136, 236 provides for added flexibility for the lures and allows for the curved end 22 of the hook 12 to move freely downwardly and inwardly towards the junction 128, 228 when a fish swallows the lure, thereby allowing the barb 24 to be exposed on the opposite or underside of the junction 128, 228 (see FIG. 5). The result is that hook 12 will be able to move from an essentially hidden position, as shown in FIGS. 1-4, to a position where it will retain a fish, as shown in FIG. 5.

FIG. 5 demonstrates the action of ensnaring a fish 5. The fish 5 is shown swallowing the lure 210. As the fish 5 goes to bite down on the lure 210, its jaws will push down on the curved end 22 of the hook 12, forcing the barb 24 to move away from the opposing end (the belly) 28b of the main body 214. The barb 24 will then be in position to ensnare the fish 5. If the fish 5 does not swallow the lure 210, or the lure 210 becomes unattached from the fish 5, possibly after catching the fish 5 and removing it from the lure 210, the hook 12 will move back to a normal position, as shown in FIG. 2. As such, the lure 210 will once again return to a state wherein the possibility of being entangled in the weeds is minimized.

The fishing lure of the present invention can also have further arrangements, as depicted in FIG. 6. Depending on the size and type of fish, it may be desirous to have a lure that has multiple hooks. FIG. 6 provides a lure 110, as shown and described in FIG. 2, with the addition of a second hook 22′ being located in the main body 114. The hook 22′ is positioned similarly to that of hook 22 previously described, but is located apart from the hook 22. The hook 22′ has a barb 24′ that is positioned on the underside or belly 114b′ of the main body 114′ and the junction 128′, with the relative inwards and outward movement of the hook 22′ being as previously described with respect to the hook 22. The hook 22′ is positioned relatively towards the top side 114a′ of the junction 128′, as with the previous arrangements of the invention, discussed above. As such, it is understood that more hooks could be used in a lure as necessary according to the present invention. Provided that the positioning and arrangement has a hook that will be surrounded by and somewhat “hide” the hook, while providing for the movement of the hook and the barb as described, the lure would fall within the scope of the present invention.

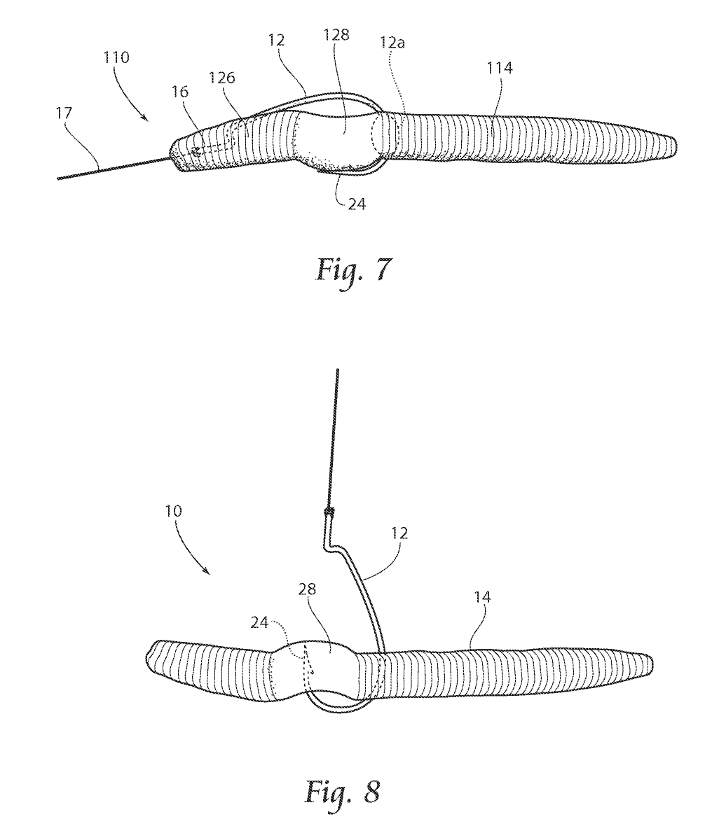

FIG. 7 provides a further arrangement of a fishing lure according to the present invention, similar to the fishing lure 110 shown in FIG. 2. The main body 114 is the same as the main body 114 shown in FIG. 2. The hook 12 has been modified with the addition of a solid body section 12a added to the hook 12 where the hook 12 intersects the junction 128. The solid body section 12a preferably is welded onto the hook, e.g. formed by the addition of solder being applied to the hook 12. The addition of the solid body section 12a provides for a further solid structure for the fishing lure 110 while the fishing lure 110 is being pulled through weeds. That is, the solid body section 12a provides support and strength for the fishing lure 110. The solid body section 12a could be incorporated into straight or angled fishing lures of the type shown and described previously. The solid body structure 12a also provides for additional resistance when being swallowed by a fish, thereby contributing to a secure ensnarement of the fish.

FIG. 8 shows another arrangement of a fishing lure that can be used for wacky style fishing. The main body 14 of the fishing lure 10 and the hook 12 have the same shape as previously described, with the hook 12 intersecting the main body 14 generally at the junction 28 of the main body 14. However, the hook 12 is arranged perpendicular to the main body 14, with the barb 24 being secured within the junction 28 of the main body 14. Though having a relatively perpendicular arrangement between the hook 12 and the main body 14, the lure will act in a similar fashion as the previous lures, described above. That is, the lure is designed to sufficiently retain a fish once the fish swallows the lure, as well as providing a lure that will not get stuck in the weeds.

The lures of the present invention can be formed in various ways. Preferably, the lure 210 will be cast with the hook 12 in place prior to casting. The main body 114 will be formed of a flexible plastic or similar material commonly used for fishing lures. Provided that the shaped lure can provides a design according to the present invention that will sufficiently retain a fish once the fish swallows the lure, as well as providing a lure that will not get stuck in weeds or similar environments, it is understood that the lure will fall within the scope of the present invention. The lures provide a hook that is partially retained within a main flexible body of the lure in such a manner that the barbed portion of the hook is protected by the main flexible body and will stay protected as the lure is used. Because the hook and the main body are integrally arranged, the barb will move with the main body, preventing it from getting entangled in weeds. Once an outside force, such as the fish 5 in FIG. 5, pushes on the hook and lure, the barb will move a sufficient distance from the main body, thereby allowing the barb to hook the fish. However, the flexible arrangement also allows for the barb to return to a protected position as shown in FIGS. 1-4 and 6 once the lure is separated from the fish 5.

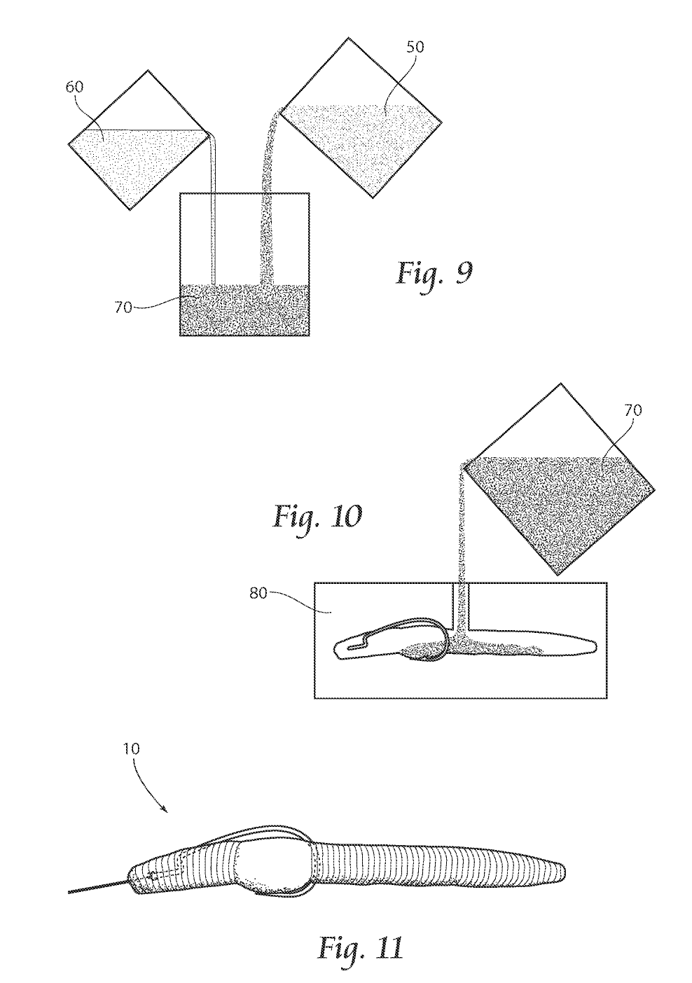

As stated above, the lures of the present invention can be formed in various ways. FIGS. 9-11 describe one such method. In FIG. 9, a liquid plastic or polymer 50 is added in conjunction with a scented material 60, such as liquid garlic. The combined mixture 70 is poured into a mold 80, as shown in FIG. 10, with the hook 12 being placed within the mold 80 prior to the combined mixture 70 being poured into the mold 80. Once the mold 80 has been filled and allowed to set, a completed lure 10 including the hook 12 is formed, as shown in FIG. 11. The hook 12 could also be added to the lure 10 after the mixture 70 has been allowed to set and the lure 10 has been removed from the mold 80. The method allows for the addition of odors or fragrances to be added to the lures in a manner that will allow the lures to retain the added smell for a longer period of time as compared to the prior art. It is possible to use any different odors as is commonly known to be incorporated into fishing lures.

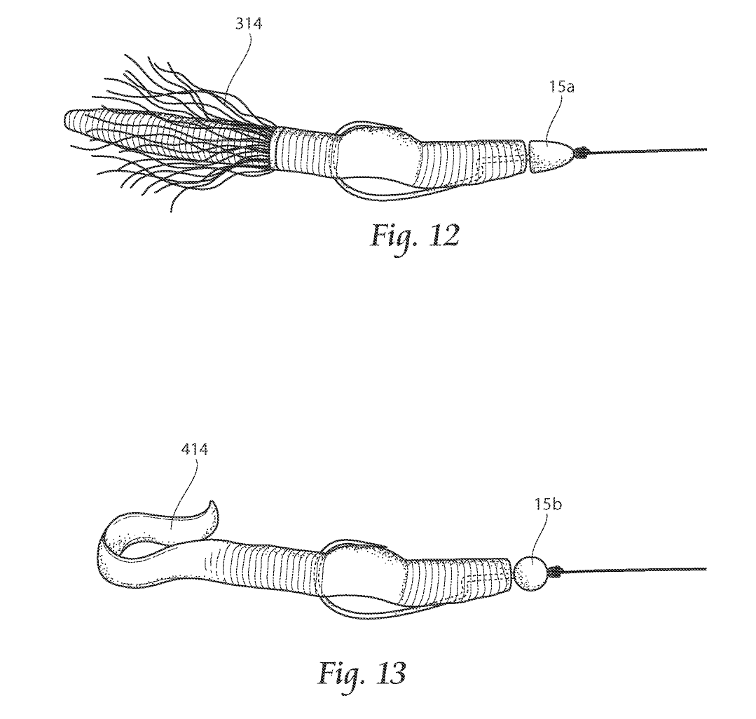

FIGS. 12 and 13 demonstrate further types of fishing lures that can incorporate the present invention. FIG. 12 shows the lure utilizing a skirt design 314, with FIG. 13 utilizing a twisting tail design 414. Both of the designs further utilize a jig head that can either be cone shaped 15a (FIG. 12) or circular 15b (FIG. 13), or other know and used shaped. Preferably, the jig head is an extra wide gap (EWG) style hook, which could assist in properly positioning the jig head so that the barb of the hook will be properly positioned to rest on the belly of the fishing lure, as previously described.

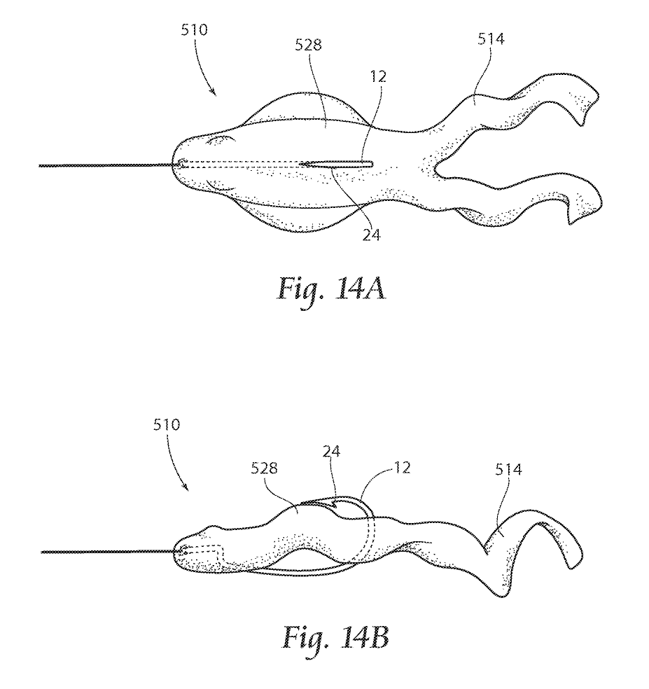

The design of the present invention could also be incorporated into other types of fishing lures and baits, as shown in FIGS. 14A and 14B. FIGS. 14A and 14B show an artificial frog lure 510 commonly used as bait, which incorporates a hook 12 arrangement as previously described with respect to the other designs. The hook 12 is allowed to sit in the junction 528 of the main body 514 as described with the other lures, above. Provided that the hook is positioned within the lure to provide the weedless design as describe herein, it is understood that any shape of the main body of the lure will fall within the scope of the present invention.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is described by the claims.

I claim:

1. A fishing lure comprising:
a main body having a top side and a belly;
a hook having a curved portion and a barbed portion, said hook being partially imbedded in said main body; and
wherein said barbed portion abuts said belly of said main body.

2. The fishing lure of claim 1, wherein said main body is flexible.

3. The fishing lure of claim 2, wherein said hook is capable of flexing with respect to said main body.

4. The fishing lure of claim 3, wherein said hook being movable from a first position abutting said belly of said main body to a second position extending outwardly from said belly when said fishing lure coming into contact with an outside force.

5. The fishing lure of claim 1 further comprising a notched section in said top side of said main body.

6. The fishing lure of claim 1 comprising a second hook.

7. The fishing lure of said claim 1, wherein said main body comprises a first section and a second section, said first section being angled with respect to said second section.

8. The fishing lure of claim 1 further comprising a solid body section located on the hook, said solid body section intersecting said main body.

9. The fishing lure according to claim 1, wherein the lure comprises a wacky style fishing lure.

10. The fishing lure according to claim 1, wherein the lure comprises a skirt located on the main body of the fishing lure.

11. The fishing lure according to claim 1, wherein the main body comprises an elongated twisting body section.

12. The fishing lure according to claim 1 wherein the main body is frog shaped.

13. A method of making the fishing lure of claim 1 including the step of molding the fishing lure, wherein a scent is added to the fishing lure prior to the step of molding the fishing lure.

14. A fishing lure comprising:
a hook having a shaft having a curved section, said curved section terminating in a barb;
a flexible main body comprising a first section, a second section, and a junction located intermediate of said first and said second section;
said junction comprising a top side and a belly;
said hook being partially embedded in said main body and having a solid body section intersecting the flexible main body, wherein said a portion of said curved section of said hook extending outwardly of said top side of said junctions, said barb of said hook abutting said belly of said junction, said barb being further capable of moving a distance away from said belly.
